(19) United States
(12) Patent Application Publication
(10) Pub. No.: US 2013/0104153 A1
(43) Pub. Date: Apr. 25, 2013

(54) SYSTEM AND METHOD OF CONTROLLING A PROCESSING DEVICE FOR AUTOMATICALLY AND CONTINUOUSLY PROCESSING DISCS

(71) Applicants: Ming-Hsun Liu, Taipei (TW); Chih-Sheng Liu, Taipei (TW)

(72) Inventors: Ming-Hsun Liu, Taipei (TW); Chih-Sheng Liu, Taipei (TW)

(21) Appl. No.: 13/278,640

(22) Filed: Oct. 21, 2011

(51) Int. Cl. G11B 17/04

(52) U.S. Cl. 720/606; G9B/17.018

(57) ABSTRACT

A system and a method of controlling a processing device for automatically and continuously processing discs are disclosed. The method comprises: determining if a tray in a processing system is opened by adapting a first sensor; determining if any one of the discs is loaded in the tray by adapting the second sensor; in the event of the tray being opened and one disc being loaded, unloading the loaded disc by adapting a transporting device; in the event of the tray being opened and no disc being loaded, loading one disc by adapting the transporting device; and closing the tray for processing the one disc being loaded in the tray transported by the transporting device and controlled by the computer.

### BACKGROUND OF THE INVENTION

1. Field of the Invention

The present invention relates to a system and a method of controlling a processing device for automatically and continuously processing discs.

2. Description of the Related Art

There are more and more software, such as NERO™, iTUNE™, or MultiMedia Player™ etc., developed for automatically processing discs (such as copying, ripping, recording, decoding, and/or printing discs) by using a general PC with a processing device. Traditionally, the processing software, taking “NERO” as an example, needs a user to open a tray in a processing system, (normally, a general PC), load a disc onto the tray, and close the tray for NERO to process the disc. Normally, NERO will check the status of the disc and process the disc automatically. After processing the disc, NERO will control OS (operation system) of a computer to automatically open the tray for the user to unload the processed disc manually. When the user wants to process more than one disc, it requires the user to load another disc manually onto the tray for processing.

All kinds of discs can be reproduced/printed/ripped/recorded/decoded with a disc processing device, such as that disclosed in U.S. Pat. No. 7,650,612 or U.S. application Ser. No. 12/623,518, for a reasonable amount of copies. However, the traditional processing device is a standalone device, which means that the traditional processing device can control the device for automatically and continuously processing when there are more than 2 discs to be processed because it was designed with a firmware to process the discs only without connecting with a computer.

Thus, the owner of the processing system requires developing not only for the processing device but also for the software using for the processing device. When adapting the well-developed processing software, it is possible for the owner of the processing device to reduce the cost of developing the software and for the users to process the discs more easily.

Therefore, there is a need to provide a system and a method of controlling a processing device, through a general PC, so as to automatically and continuously process discs.

### SUMMARY OF THE INVENTION

It is an object of the present invention to provide a system and a method of controlling a processing device for automatically and continuously processing discs.

To achieve the abovementioned object, the present invention provides a method of controlling a processing device for automatically and continuously processing discs, wherein the processing device comprises a first sensor, a second sensor, a tray for loading each of the discs, and the processing device is connected to a transporting device for transporting each of the discs and a computer having a CPU executing a processing software program so as to control the tray and process the discs, the method comprising:

Step 1: determining if the tray in the processing system is opened by adapting the first sensor;

Step 2: determining if any one of the discs is loaded in the tray by adapting the second sensor;

Step 3: in the event of the tray being opened and one disc being loaded, unloading the loaded disc by adapting the transporting device;

Step 4: in the event of the tray being opened and no disc being loaded, loading one disc by adapting the transporting device; and

Step 5: closing the tray for processing the one disc being loaded in the tray transported by the transporting device and controlled by the computer.

With respect to another aspect of the present invention, a processing system is provided for communicating between a processing device and an operating system (OS) of a computer. The processing device comprises a tray for loading a disc, a first sensor for sensing if the tray is opened, and a second sensor for sensing if the disc is loaded.

The processing system comprises a first enquiring module, a second enquiring module, and a control module. The first enquiring module enquires the processing device if the tray is opened that is sensed by the first sensor. The second enquiring module enquires the processing device if the disc is loaded that is sensed by the second sensor. The control module controls the OS to load the disc in the event of the tray being opened and no disc being loaded, and controlling the OS to close the tray after the disc is loaded.

Preferably, the disc is a CD, a DVD, or a BD.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1A illustrates an environmental schematic drawing according to an embodiment of the present invention.

FIG. 1B shows a perspective view of a processing device.

FIG. 2A illustrates an operational schematic drawing according to an embodiment of the present invention.

FIG. 2B illustrates an operational schematic drawing according to another embodiment of the present invention.

FIG. 3 illustrates a flow chart according to the method of the present invention.

Other objects, advantages, and novel features of the invention will become more apparent from the following detailed description when taken in conjunction with the accompanying drawings.

### DETAILED DESCRIPTION OF THE PREFERRED EMBODIMENT

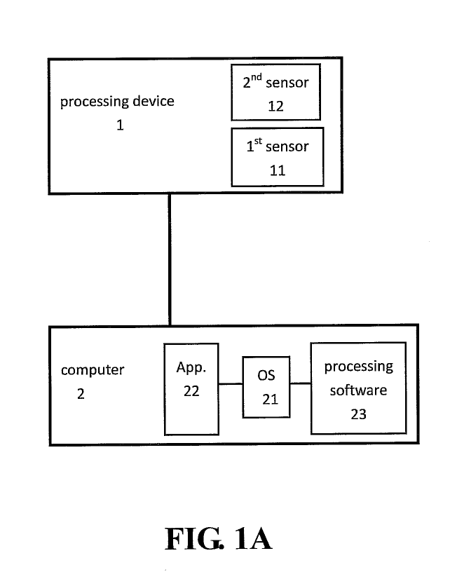

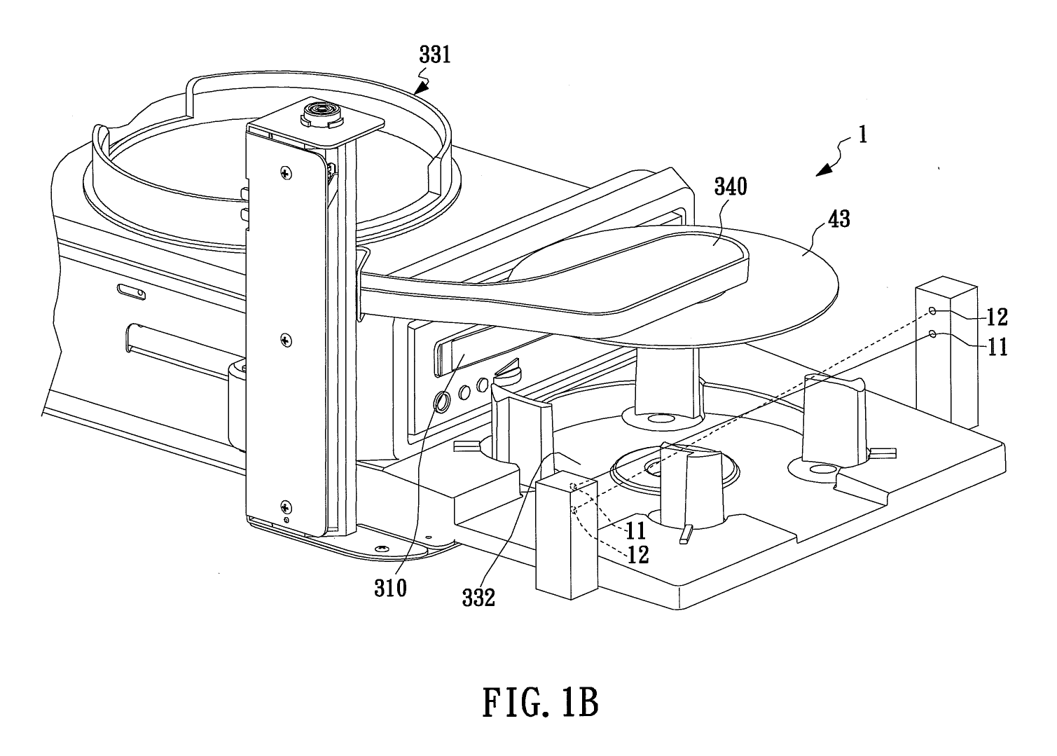

Please refer to FIG. 1A, which illustrates an environmental schematic drawing. A processing device 1 comprises a first sensor 11 and a second sensor 12. The processing device 1 is a traditional device used for reproducing, printing, recording, decoding, or ripping discs. The processing device 1 is connected to a computer 2. The computer 2 stores with an OS (operating system) 21, such as Windows, Windows CE, Mac, Linux, Unix, a cellular phone OS, or a proprietary OS, which is a prior art thus not described in detail herein for the sake of brevity.

In addition, the computer 2 further stores with a processing software 23, such as well-developed software of NERO™, iTUNE™, or MultiMedia Player™ etc. In this embodiment, the present invention may be in the form of an application software 22 stored in the computer 2. The application software may be a computer program product for operating the processing device 1.

FIG. 1B shows a perspective view of the processing device 1. The processing device 1 comprises a tray 310 for loading a disc 43. The first sensor 11 senses if the tray 310 is opened, and the second sensor 12 senses if the disc 43 is loaded onto the tray 310. Preferably, one set first sensor 11 disposes on the same height with the tray 310 for sensing if the tray 310 is opened or not, and one set second sensor 12 disposes on different height with an angle (about 3-80 degrees) for sensing if the disc is loaded or not. The processing device 1 further comprises a first receptacle portion 331 for containing blank discs (not shown), a second receptacle portion 332 for containing processed discs (not shown), and a transporting device 340. The transporting device 340 picks one disc from the first receptacle portion 331 to the tray 310 when the tray 310 is opened. Then, the tray 310 is closed for processing the disc, such as reproducing, printing, recording, decoding, or ripping the disc. When the tray 310 is opened again, the disc in the tray is processed. Then the transporting device 340 picks the processed disc from the tray 310 to the second receptacle portion 332. The transporting device 340 is only an example, which is not used for limiting the present invention. In general, the transporting device 340 can be designed into the processing device 1; alternatively, the transporting device 340 can be separated with the processing device 1 as an independent device controlled by the computer 2.

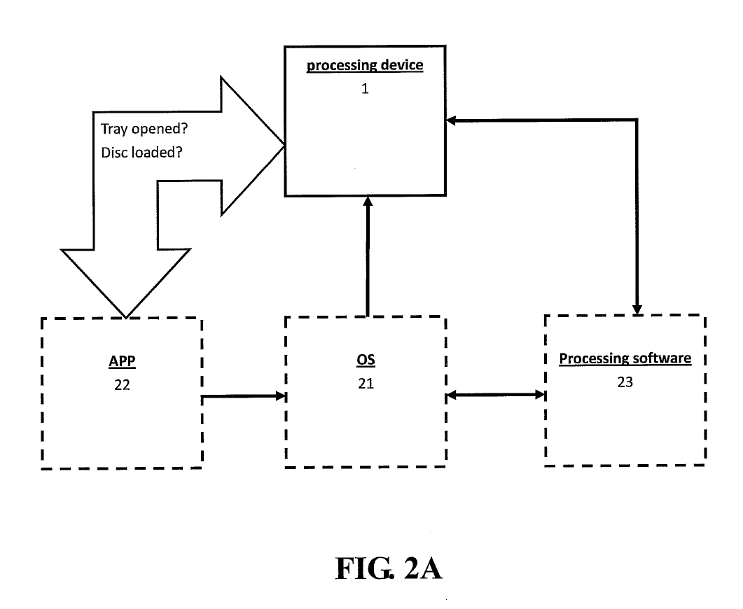

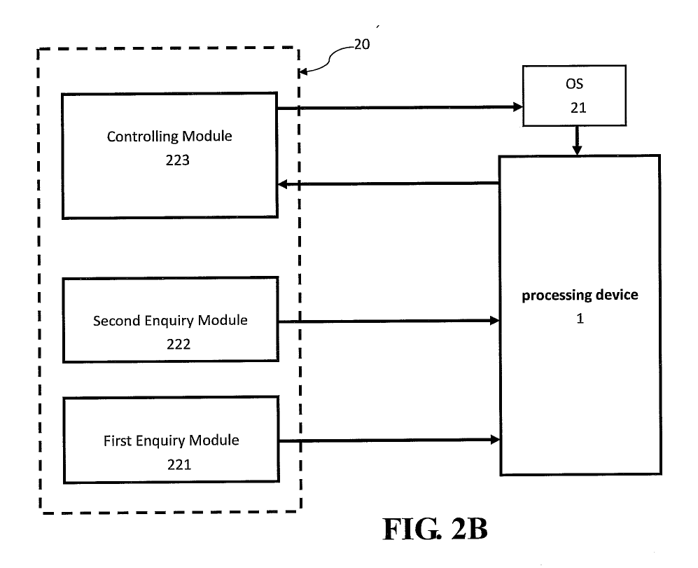

As shown in the FIG. 1A and FIG. 2A, the application software 22 enquires the processing device 1 if the tray 310 is opened and enquires the processing device 1 if the disc 43 is loaded. In the event of the tray 310 is opened and one disc is loaded, the application software 22, executed by a CPU of the computer 2, will notify the OS 21 to execute unloading the loaded disc. In the event of the tray 310 is opened and no disc is loaded (after unloading), the application software 22 will notify the OS 21 to execute loading one disc and then closing the tray 310. In this embodiment, as shown in FIG. 1B, the transporting device 340 will pick one blank disc from the first receptacle portion 331 to the tray 310 and close the tray 310 for the processing device 1 to process the blank disc by using the above-mentioned well-developed processing software.

When the disc is processed, the tray 310 will be opened automatically according those well-developed processing software. Thus, when the tray 310 is opened and the disc is loaded, the application software 22 will notify the OS to execute unloading the loaded (processed) disc. Accordingly, the present invention can process discs (more than one disc) automatically and continuously accompanying with the well-developed processing software.

In another embodiment, the present invention also provides a processing system 20 comprising a first enquiring module 221, a second enquiring module 222, and a control module 223. The first enquiring module 221 enquires the processing device 1 if the tray 310 is opened that is sensed by the first sensor 11. The second enquiring module 222 enquires the processing device 1 if the disc is loaded that is sensed by the second sensor 12. The control module 223 controls the OS 21 to load the disc in the event of the tray 310 being opened and no disc being loaded and to close the tray 310 when the disc is loaded. The control module 223 further controls the OS to close the tray 310 when the disc is loaded.

In this embodiment, the aforesaid modules can not only come in the form of a hardware device, a software program, firmware, or a combination thereof, but also come in the form of a circuit loop or any other appropriate arrangement. If any one of the modules is implemented by software, it can be loaded on a computer-readable storage medium. Each of the elements can be self-contained; alternatively, the elements can operate in conjunction with each other. Furthermore, this embodiment is intended to be illustrative of a preferred embodiment of the present invention, and is not described in detail in terms of any possible combination of variations for the sake of brevity. However, persons skilled in the art should be able to understand that the present invention can, for the purpose of the implementation thereof, require any other more delicate conventional modules or elements. The modules or elements can be omitted or altered as needed. Any other module or element is not necessarily absent between any two of the modules.

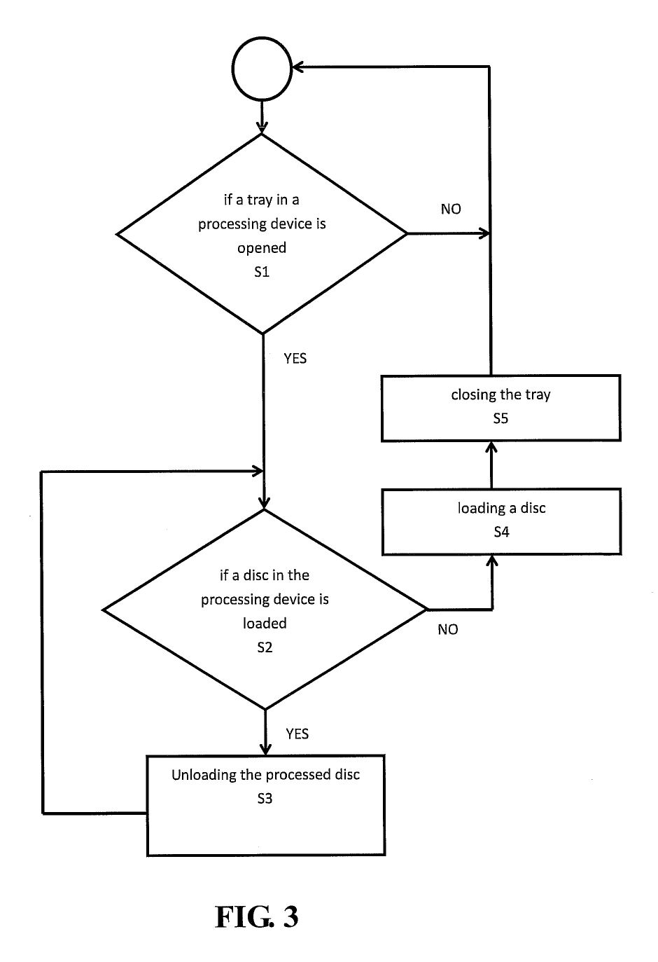

Please refer to FIG. 3, which shows a flow chart of a method of controlling a processing device for automatically and continuously processing discs according to the present invention. The processing device comprises a first sensor, a second sensor, a tray for loading each of the discs, and the processing device is connected to a transporting device for transporting each of the discs and a computer having a CPU executing a processing software program so as to control the tray and process the discs. The method comprises:

S1: determining if the tray in the processing system is opened by adapting the first sensor;

S2: determining if any one of the discs is loaded in the tray by adapting the second sensor;

S3: in the event of the tray being opened and one disc being loaded, unloading the loaded disc by adapting the transporting device;

S4: in the event of the tray being opened and no disc being loaded, loading one disc by adapting the transporting device; and

S5: closing the tray for processing the one disc being loaded in the tray transported by the transporting device and controlled by the computer.

Preferably, the disc is a CD, a DVD, or a BD.

Although the present invention has been explained in relation to its preferred embodiments, it is to be understood that many other possible modifications and variations can be made without departing from the spirit and scope of the invention as hereinafter claimed.

What is claimed is:

1. A method of controlling a processing device for automatically and continuously processing discs, wherein the processing device comprises a first sensor, a second sensor, a tray for loading each of the discs, and the processing device is connected to a transporting device for transporting each of the discs and a computer having a CPU executing a processing software program so as to control the tray and process the discs, the method comprising:
determining if the tray in the processing system is opened by adapting the first sensor;
determining if any one of the discs is loaded in the tray by adapting the second sensor;
in the event of the tray being opened and one disc being loaded, unloading the loaded disc by adapting the transporting device;
in the event of the tray being opened and no disc being loaded, loading one disc by adapting the transporting device; and
closing the tray for processing the one disc being loaded in the tray transported by the transporting device and controlled by the computer.

2. A processing system used for communicating between a processing device and an operating system (OS) of a computer, wherein the processing device comprises a tray for loading a disc, a first sensor for sensing if the tray is opened, and a second sensor for sensing if the disc is loaded, the processing system comprising:
a first enquiring module to enquire the processing device if the tray is opened that is sensed by the first sensor;
a second enquiring module to enquire the processing device if the disc is loaded that is sensed by the second sensor; and
a control module for controlling the OS to load the disc in the event of the tray being opened and no disc being loaded, and controlling the OS to close the tray when the disc is loaded.

3. The processing system as claimed in claim 1, wherein the disc is a CD, a DVD, or a BD.
